(19) United States
(12) Patent Application Publication
(10) Pub. No.: US 2022/0254319 A1
(43) Pub. Date: Aug. 11, 2022

(54) SCREEN BRIGHTNESS ADJUSTMENT METHOD AND MOBILE TERMINAL

(71) Applicant: AUTEL INTELLIGENT TECHNOLOGT CORP., LTD, Shenzhen (CN)

(72) Inventor: Liangxiang LIU, Shenzhen (CN)

(21) Appl. No.: 17/661,351

(22) Filed: Apr. 29, 2022

Related U.S. Application Data
(63) Continuation of application No. PCT/CN2020/128517, filed on Nov. 13, 2020.

(30) Foreign Application Priority Data
Nov. 13, 2019 (CN) 201911109194.8

(51) Int. Cl. G09G 5/10; G06F 3/04817; G06F 3/0484; G09G 3/20

(52) U.S. Cl. CPC G09G 5/10; G06F 3/04817; G06F 3/0484; G09G 3/2092; G09G 2354/00; G09G 2360/144; G09G 2360/141; G09G 2320/066; G09G 2320/0626

(57) ABSTRACT

A screen brightness adjustment method and a mobile terminal are provided. The screen brightness adjustment method includes: acquiring an ambient brightness value of the current application environment; acquiring a backlight level of the mobile terminal; when the ambient brightness value is greater than a first preset threshold value and the backlight level is greater than a second preset threshold value, acquiring a screen brightness adjustment parameter corresponding to the ambient brightness value; and adjusting the screen brightness of the mobile terminal according to the screen brightness adjustment parameter. When the screen brightness is adjusted according to the ambient light, the backlight of the screen is not adjusted directly, instead, the screen brightness is adjusted according to the screen brightness adjustment parameter, which makes the display effect of a screen clear and also reduces the system consumption.

### CROSS REFERENCE TO RELATED APPLICATIONS

The present application is continuation application of International Application No. PCT/CN2020/128517, filed on Nov. 13, 2020, which claims priority to the Chinese patent application No. 201911109194.8 filed on Nov. 13, 2019, the entire contents of which are incorporated herein by reference.

### BACKGROUND

### Technical Field

The present application relates to the technical field of terminal equipment, and particularly to a screen brightness adjustment method and a mobile terminal.

### Related Art

Currently, almost all terminal equipment such as smartphones, tablet computers, and other mobile terminals has a built-in light sensor to detect the intensity of ambient light through the light sensor and adjust the screen brightness of the terminal equipment according to the intensity of ambient light. Under most circumstances of adjusting the screen brightness of terminal equipment, the screen brightness is adjusted by controlling the screen backlight.

However, generally, the backlight power consumption of a display screen is relatively large. If the backlight is adjusted for a display effect in a high brightness environment, the power consumption of terminal equipment is thus increased, thereby reducing the time of endurance of the terminal equipment and shortening the battery life in the long term.

### SUMMARY

The technical problem to be solved by the present application is to provide a screen brightness adjustment method and a mobile terminal, and solve the technical problem of high power consumption existing in the prior art when adjusting the screen brightness.

An aspect of an embodiment of the present application provides a screen brightness adjustment method applied to a mobile terminal, the method including:

acquiring an ambient brightness value of a current application environment;

acquiring a backlight level of the mobile terminal;

when the ambient brightness value is greater than a first preset threshold value and the backlight level is greater than a second preset threshold value, acquiring a screen brightness adjustment parameter corresponding to the ambient brightness value; and

adjusting the screen brightness of the mobile terminal according to the screen brightness adjustment parameter.

Optionally, the step of acquiring a screen brightness adjustment parameter corresponding to the ambient brightness value comprises:

searching for a backlight reference current and an image rendering parameter corresponding to the ambient brightness value in a preset mapping table, and the screen brightness adjustment parameter comprising the backlight reference current and the image rendering parameter.

Optionally, the step of adjusting the screen brightness of the mobile terminal according to the screen brightness adjustment parameter comprises:

adjusting a backlight reference current of the mobile terminal to an acquired backlight reference current; and

rendering an image displayed on a display screen of the mobile terminal according to the image rendering parameter.

Optionally, the step of rendering an image displayed on the display screen of the mobile terminal according to the image rendering parameter comprises:

setting a layer respectively for application programs displayed on the display screen, and applying for a memory space for each layer;

decomposing a UI icon of the application program displayed on the screen into a display node, and storing the display node in a preset queue; and

reading a display node in the queue, and performing image rendering on the display node according to the image rendering parameter.

Optionally, the image rendering parameter includes image greyscale, image contrast, and image saturation.

Another aspect of an embodiment of the present application provides a mobile terminal including a light sensor and a microprocessor.

The light sensor is configured to collect an ambient brightness value of a current application environment. The microprocessor comprises at least one processor, and a memory communicatively connected to at least one processor, the memory storing an instruction executable by at least one processor, and the instruction being executed by at least one processor to enable the at least one processor to execute:

acquiring the ambient brightness value;

acquiring a backlight level of the mobile terminal;

when the ambient brightness value is greater than a first preset threshold value and the backlight level is greater than a second preset threshold value, acquiring a screen brightness adjustment parameter corresponding to the ambient brightness value; and

adjusting the screen brightness of the mobile terminal according to the screen brightness adjustment parameter.

Optionally, the screen brightness adjustment parameter comprises a backlight reference current and an image rendering parameter, and the processor is further configured to search for a backlight reference current and an image rendering parameter corresponding to the ambient brightness value in a preset mapping table.

Optionally, the processor is further adjust a backlight reference current of the mobile terminal to an acquired backlight reference current.

Optionally, the mobile terminal further comprises an image processor.

The image processor is used for rendering an image displayed on the screen according to the image rendering parameter.

Optionally, the mobile terminal further comprises a drive program interface and a display, wherein the image processor is configured to:

set a layer respectively for application programs displayed on the screen, and applying for a memory space for each layer;

decompose a UI icon of the application program displayed on the screen into a display node, and storing the display node in a preset queue;

read a display node in the queue, and perform image rendering on the display node according to the image rendering parameter;

write rendered display node into a memory space corresponding to the display node;

superimpose layers corresponding to the memory space with written display node, and transmit superimposed data to the drive program interface;

wherein the drive program interface is configured to transmit the superimposed data to the display; and the display is configured to display a rendered image.

The third aspect of an embodiment of the present application provides a display screen brightness adjustment apparatus applied to a mobile terminal, the apparatus including: a first acquisition module configured to acquire an ambient brightness value of a current application environment; a second acquisition module configured to acquire a backlight level of the mobile terminal; a third acquisition module configured to acquire a screen brightness adjustment parameter corresponding to the ambient brightness value when the ambient brightness value is greater than a first preset threshold value and the backlight level is greater than a second preset threshold value; and a brightness adjustment module configured to adjust the screen brightness of the mobile terminal according to the screen brightness adjustment parameter.

The third acquisition module is further configured to search for a backlight reference current and an image rendering parameter corresponding to the ambient brightness value in a preset mapping table, and wherein the screen brightness adjustment parameter comprises the backlight reference current and the image rendering parameter.

The brightness adjustment module comprises a backlight current adjustment unit and an image rendering unit, wherein the backlight current adjustment unit is configured to adjust a backlight reference current of the mobile terminal to an acquired backlight reference current; and the image rendering unit is configured to render an image displayed on a display screen of the mobile terminal according to the image rendering parameter.

The image rendering unit is further configured to: set a layer respectively for application programs displayed on the display screen, and apply for a memory space for each layer; decompose a UI icon of the application program displayed on the screen into a display node, and store the display node in a preset queue; and read a display node in the queue, and perform image rendering on the display node according to the image rendering parameter.

An embodiment of the present application provides a screen brightness adjustment method and a mobile terminal, comprising: acquiring an ambient brightness value of a current application environment and a backlight level of a mobile terminal; acquiring a screen brightness adjustment parameter according to the ambient brightness value when the ambient brightness value and the backlight level of the mobile terminal both satisfy a preset condition; and finally adjusting a screen height of the mobile terminal according to the screen brightness adjustment parameter. When the screen brightness is adjusted according to the ambient light, the backlight of the screen is not adjusted directly, instead, the screen brightness is adjusted according to the screen brightness adjustment parameter, which makes the display effect of a screen clear and also reduces the system consumption.

### BRIEF DESCRIPTION OF THE DRAWINGS

One or more embodiments are exemplified by the accompanying drawings corresponding thereto. These exemplified descriptions do not constitute a limitation on the embodiments. Elements in the drawings having the same reference number designations are illustrated as similar elements, and unless otherwise particularly stated, the drawings do not constitute a proportional limitation.

FIG. 1 is a schematic view showing a structure of a mobile terminal provided by an embodiment of the present application;

FIG. 2 is a flowchart of a screen brightness adjustment method provided by an embodiment of the present application;

FIG. 3 is a flowchart of a method for rendering an image displayed on a screen according to an image rendering parameter provided by an embodiment of the present application;

FIG. 4 is an effect picture before performing image enhancement processing provided by an embodiment of the present application;

FIG. 5 is an effect picture after performing image enhancement processing provided by an embodiment of the present application;

FIG. 6 is a schematic view showing the structure of a screen brightness adjustment apparatus provided by an embodiment of the present application;

### DESCRIPTION OF EMBODIMENTS

In order to make the objects, technical solutions, and advantages of the present application more clearly understand, a more particular description of the present application will be rendered below by reference to the appended drawings and embodiments. It should be understood that the specific embodiments described herein are illustrative only and are not limiting.

It should be noted that various features of the embodiments of the present application, without conflicts, can be combined with one another without departing from the scope of the application. In addition, although the division of functional modules is illustrated in a schematic view of an apparatus and a logical order is illustrated in a flowchart, in some cases, the steps shown or described may be executed in a different order from the flowchart or according to the module division different from the schematic view of an apparatus.

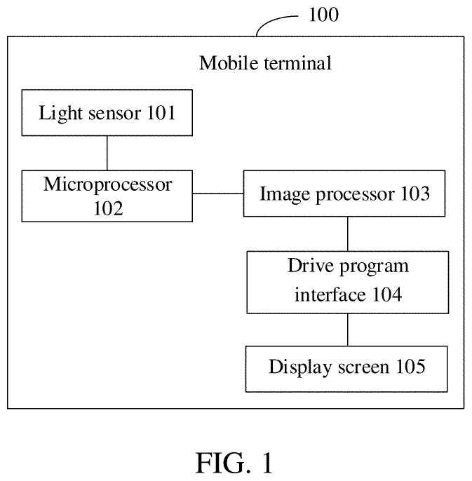

Referring to FIG. 1, FIG. 1 is a schematic view showing a structure of a mobile terminal provided by an embodiment of the present application. The mobile terminal 100 includes a light sensor 101, a microprocessor 102, an image processor 103, a drive program interface 104, and a display screen 105. The microprocessor 102 is connected to the light sensor 101 and the image processor 103, respectively, and the image processor 103 is connected to the display screen 105 through the drive program interface 104.

The light sensor 101 is configured to collect an ambient brightness value of a current application environment, and transmit the collected ambient brightness value to the microprocessor 102. The number of the light sensors 101 may be one or more. The light sensor 101 can be located at the lower end of the display screen 105 of the mobile terminal 100 so as to avoid the light emitted by the display screen 105 itself interfering with the detection of the light sensor 101. In practical applications, the light sensor 101 can also be arranged at other positions of the mobile terminal 100.

The microprocessor 102 is the core of the mobile terminal 100, and is configured to adjust the screen brightness of the display screen 105. The microprocessor 102 can execute one or more logical judgment steps, and communicate a corresponding interface to realize the interaction with external equipment (for example, obtaining an ambient brightness value from a light sensor 101, transmitting an image rendering parameter to the image processor 103, etc.). The microprocessor 102 may be any suitable processor having computing and logic control functions, such as a single chip microcomputer, etc.

In the present embodiment, the microprocessor 102 may include: at least one processor, and a memory communicatively connected to at least one processor.

The processor may be any suitable type of single-threaded or multi-threaded processor having one or more processing cores to serve as the core of the microprocessor 102 to acquire data, execute logical operation functions, and issue an operation processing result.

The memory serves as a non-volatile computer-readable storage medium such as at least one disk storage device, flash memory device, distributed storage equipment remotely located from the processor, or other non-volatile solid-state storage devices. The memory may have a data storage area for storing the operation processing result issued by the processor. The memory may also have a program storage area for storing non-volatile software programs, non-volatile computer-executable programs, and modules for calling by the processor to cause the processor to execute one or more method steps. In the present embodiment, the memory stores an instruction executable by at least one processor, and the instruction is executed by at least one processor to enable at least one processor to perform the executions of: acquiring the ambient brightness value; acquiring a backlight level of the mobile terminal 100; when the ambient brightness value is greater than a first preset threshold value and the backlight level is greater than a second preset threshold value, acquiring a screen brightness adjustment parameter corresponding to the ambient brightness value; and adjusting the screen brightness of the mobile terminal 100 according to the screen brightness adjustment parameter.

The ambient brightness value is obtained from the light sensor 101. The backlight level of the mobile terminal 100 refers to a parameter for reflecting the backlight brightness of the display screen 105 of the mobile terminal 100. The backlight brightness can be determined according to relevant parameters of a light-emitting element, such as voltage, current, etc of the light-emitting element. The current backlight level of the mobile terminal 100 may be automatically acquired by the processor.

The screen brightness adjustment parameter comprises a backlight reference current and an image rendering parameter. The processor is further configured to: search for a backlight reference current and an image rendering parameter corresponding to the ambient brightness value in a preset mapping table so as to obtain the backlight reference current and the image rendering parameter corresponding to the current ambient brightness value. The image rendering parameters include image grayscale, image contrast, image saturation, image sharpening, image resolution, etc. A mapping table for a corresponding relationship between the ambient brightness value and the backlight reference current and the image rendering parameter can be pre-established. After acquiring the ambient brightness value of the current application environment, the backlight reference current and the image rendering parameter are acquired by looking up the table. The mapping table can be obtained by a number of repeated experiments.

The backlight reference current is used for adjusting the backlight current of the mobile terminal 100, and the image rendering parameter is used for adjusting an effect of an image displayed on a screen of the mobile terminal 100. By simultaneously adjusting the backlight reference current and the image rendering parameter, the backlight power consumption of the mobile terminal 100 can be not increased under the condition of ensuring a good screen display effect.

The processor is further configured to adjust the backlight reference current of the mobile terminal to the acquired backlight reference current. The microprocessor 102 transmits the image rendering parameter to an image processor (Graphics Processing Unit, GPU) 103 which is configured to render the image displayed on the dispaly screen 105 according to the image rendering parameter.

Specifically, the image processor 103 is configured to: respectively set a layer for an application program displayed on the screen, and apply for a memory space for each layer; decompose a UI icon of the application program displayed on the screen into a display node, and store the display node in a preset queue; read a display node in the queue, and perform image rendering on the display node according to an image rendering parameter; write the rendered display node into the memory space corresponding to the display node; and superimpose layers corresponding to the memory space with written display node, and transmit the superimposed data to the drive program interface 104.

The image processor 103 may comprise an image synthesizer, and the image synthesizer is configured to superimpose layers corresponding to a memory space with a written display node, and transmit the superimposed data to the drive program interface 104.

The drive program interface 104 is configured to transmit data transferred by the image processor 103. The drive program interface 104 may be viewed as a memory, and either writing data to the memory or reading data can be performed. In the present embodiment, the superimposed data is transmitted to the display screen 105 through the drive program interface 104. The display screen 105 is configured to display a rendered image according to the superimposed data.

The mobile terminal 100 of the embodiments exists in a variety of forms, including but not limited to: a mobile phone, a tablet computer, an electronic book, an intelligent bracelet, a handheld game player, vehicle-mounted navigation equipment, and other terminal equipment including the display screen 105.

In the present embodiment, the mobile terminal 100 can render an image displayed on a screen according to an image rendering parameter when the ambient light is very bright. At the same time, the backlight reference current is adjusted to a suitable range of backlight current without needing to enhance the backlight current due to the bright ambient light. The mobile terminal 100 can not only make the display effect of the screen clearer, and make the screen display effect meet the requirements of the current application environment, but also can reduce the power consumption of the system.

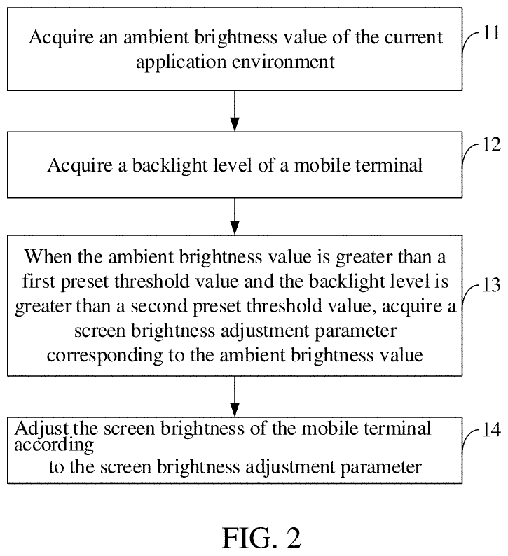

Reference is now made to FIG. 2, which is a flowchart of a display screen brightness adjustment method provided by an embodiment of the present application. The method is applied to the mobile terminal 100, which specifically includes a mobile phone, a tablet computer, an electronic book, an intelligent bracelet, a handheld game player, vehicle-mounted navigation equipment, and other terminal equipment including a display screen. The mobile terminal 100 further comprises at least one light sensor 101 for detecting the ambient light. In the present embodiment, a system (a system of the mobile terminal) to which the screen brightness adjustment method which is applicable to a mobile terminal can be applied may be an Android system, an IOS system, or a Windows phone system, etc. Specifically, as shown in FIG. 2, the method comprises:

step 11, acquiring an ambient brightness value of the current application environment.

The ambient brightness value of the application environment may be collected by a light sensor 101 built in the mobile terminal 100.

The ambient brightness value can be collected by triggering the light sensor 101. For example, a user triggers a certain physical key or a virtual key on a mobile terminal 100 so as to trigger the light sensor 10 to collect the ambient brightness value; alternatively, the user may voice-control the light sensor 101 to collect the ambient brightness value, etc. It may also be that the mobile terminal 100 controls the light sensor 101 to collect the ambient brightness value according to a preset condition. For example, the mobile terminal 100 acquires a system time and a current location of itself. When the system time and the current location of itself both satisfy the preset condition, the light sensor 101 is controlled to collect the ambient brightness value. For example, the system time is 12 o'clock noon, and the mobile terminal 100 is currently located outdoors such that the preset condition is satisfied. So the light sensor 101 is triggered to collect a current application ambient brightness value.

The number of the light sensors 101 may be one or more, and the light sensor 101 may be located at the lower end of the display screen 105 of the mobile terminal 100 so as to prevent the light emitted from the display screen 105 from interfering with the detection of the light sensor 101.

It should be noted that the ambient brightness value may be detected in other ways than the method of detecting the ambient brightness value of a current application environment via the light sensor. For example, devices such as photoresistors. Based on this hardware arrangement, when the brightness of the ambient light to which the mobile terminal 100 is exposed changes, the light sensing unit can feedback this change to the system plane of the mobile terminal 100.

Step 12, acquiring a backlight level of the mobile terminal 100.

The backlight level of the mobile terminal 100 refers to a parameter for reflecting the backlight brightness of the display screen 105 of the mobile terminal 100. For example, in the current Android system, the brightness order of the screen ranges from 0 to 255, 255 being the maximum backlight level. The user can adjust the backlight brightness of the display screen based on the range of 0 to 255 order. In practical applications, the backlight level corresponding to the Android system can also be 0 to 1024 order, 0 to 2048 order, etc.

Generally, the backlight mode of the mobile terminal 100 comprises an automatic backlight mode and a manual backlight mode. The automatic backlight mode is to automatically adjust the backlight level of the display screen 105 according to the current ambient light intensity. The manual backlight mode is to set one backlight level by a user and maintain the backlight level at all times, and the backlight level is modified by the user when the backlight level needs to be modified. Both of the backlight modes are applicable to the present embodiment. The current backlight level of the mobile terminal 100 is automatically acquired by a system plane of the mobile terminal 100.

Step 13, when the ambient brightness value is greater than a first preset threshold value and the backlight level is greater than a second preset threshold value, acquiring a screen brightness adjustment parameter corresponding to the ambient brightness value.

The first preset threshold value and the second preset threshold value can be parameters set by an operating system (for example, Android system) of the mobile terminal 100, and are already set when the mobile terminal 100 leaves the factory. The first preset threshold value is a light brightness value. When the ambient brightness value of the current environment is greater than the first preset threshold value, it indicates that the current environment is a high-brightness environment. Therefore, a person skilled in the art can specifically set the first preset threshold value according to experience. The second preset threshold value represents a backlight level. In the present embodiment, the hardware maximum backlight level of the mobile terminal is 255, and the second preset threshold value can be set according to 255*94%, namely, the second preset threshold value is 240. Of course, in practical applications, the second preset threshold value may also be other parameters, not just limiting to 240.

When the ambient brightness value is greater than the first preset threshold value and the backlight level is greater than the second preset threshold value, acquiring a screen brightness adjustment parameter corresponding to the ambient brightness value. In the present embodiment, one corresponding relationship mapping table is provided between the ambient brightness value and the screen brightness adjustment parameter. The screen brightness adjustment parameter comprises a backlight parameter and an image rendering parameter, the backlight parameter comprises a backlight reference current, a backlight reference voltage, etc., and the image rendering parameter comprises image greyscale, image contrast, image saturation, image sharpening, image resolution, etc. A mapping table for a corresponding relationship between the ambient brightness value and the backlight parameter and the image rendering parameter can be pre-established. The screen brightness adjustment parameter is acquired by looking up a table after acquiring the ambient brightness value of the current application environment.

When the screen brightness adjustment parameter is a backlight reference current and an image rendering parameter, acquiring the screen brightness adjustment parameter corresponding to the ambient brightness value comprises: searching for a backlight reference current and an image rendering parameter corresponding to the ambient brightness value in a preset mapping table, wherein the backlight reference current and the image rendering parameter are the screen brightness adjustment parameters. The operating system of the mobile terminal 100 looks up a table according to the ambient brightness value to find a backlight reference current and an image rendering parameter corresponding to the current ambient brightness value in the preset mapping table.

The preset mapping table comprises an ambient brightness value, and a backlight parameter and an image rendering parameter corresponding to the ambient brightness value. The numerical values in the mapping table can be specifically obtained through multiple experiments. For example, an example of the mapping table is given in Table 1 below, where Lumix represents the ambient brightness, the backlight parameter is the backlight reference current, and the rendering parameters include image grayscale, contrast, and saturation.

TABLE 1

| | Current Base | Image | | |
|---|---|---|---|---|
| Lumix | (MA) | grayscale | Contrast | Saturation |
| 13600 | 20 | 0.62 | 1.84 | 1.5 |
| 13000 | 19.2 | 0.64 | 1.8 | 1.45 |
| 12500 | 18.6 | 0.68 | 1.73 | 1.4 |
| 12000 | 17.8 | 0.74 | 1.65 | 1.35 |
| 11500 | 17.2 | 0.8 | 1.57 | 1.3 |
| 11000 | 16.6 | 0.86 | 1.49 | 1.24 |
| 10000 | 16 | 0.9 | 1.4 | 1.18 |
| 9000 | 15.8 | 0.92 | 1.3 | 1.1 |
| 8000 | 15.6 | 0.94 | 1.2 | 1.06 |
| 7000 | 15.4 | 0.97 | 1.12 | 1.04 |
| 6000 | 15.2 | 0.99 | 1.06 | 1.02 |
| 5000 | 15 | 1 | 1 | 1 |
| 4000 | 14 | 1 | 1 | 1 |

The backlight reference current is used for adjusting the backlight current of the mobile terminal 100, and the image rendering parameter is used for adjusting an effect of an image displayed on a screen of the mobile terminal. By simultaneously adjusting the backlight reference current and the image rendering parameter, the backlight power consumption of the mobile terminal 100 can be not increased under the condition of ensuring a good screen display effect.

Step 14, adjusting the screen brightness of the mobile terminal 100 according to the screen brightness adjustment parameter.

Adjusting the screen brightness of the mobile terminal 100 according to the screen brightness adjustment parameter comprises: adjusting the backlight reference current of the mobile terminal 100 to the acquired backlight reference current; and rendering the image displayed on the screen according to the image rendering parameter.

The backlight reference current of the mobile terminal 100 is adjusted to an acquired backlight reference current, and the acquired backlight reference current can be a backlight current within a suitable range for maintaining screen display, and the power consumption of the system is not accelerated when the backlight current is used. For example, if the default backlight current of the system is 20MA (namely, the current when the backlight level is maximum), the acquired backlight reference current may be 14MA, or the acquired backlight reference current continues to remain 20MA.

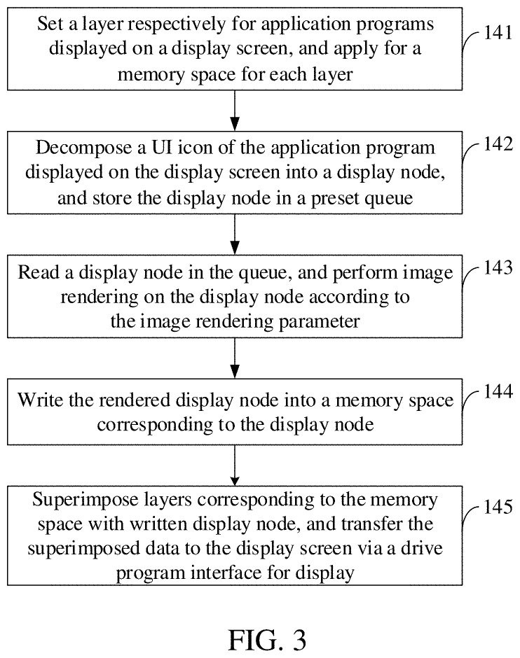

The present embodiment mainly improves the screen display effect by rendering an image in the following manner. Specifically, as shown in FIG. 3, rendering an image displayed on the screen according to the image rendering parameter includes steps below.

Step 141, respectively setting a layer for the application programs displayed on the display screen 105, and applying for a memory space for each layer.

Typically, the display screen 105 displays multiple application programs, the multiple application programs respectively corresponding to a layer, and each layer applying for a memory.

Step 142, decomposing a UI icon of the application program displayed on the display screen 105 into a display node, and storing the display node in a preset queue.

Each UI displayed on the display screen 105 can be decomposed into each display node via a hardware accelerator of an Android system. Specifically, what content an image needs to display is usually defined into one layout file by an application. When the application starts, the layout file is parsed to generate one sub-window, and the hardware accelerator of the Android system parses the attribute of each sub-window so as to obtain the parameter of each display node.

How many display nodes a UI icon is decomposed into is determined according to the display content of a display interface. For example, if one display interface displays one picture, then the display interface corresponds to one display node; if the display interface contains 10 pictures, then the display interface corresponds to 10 display nodes. Each display node contains the window size, window position, content, color, etc.

The preset queue may be one data storage list for storing the display node. When the display node is stored in the queue, all the display nodes corresponding to one application program can be stored in one group, and the display node is stored in sequence according to the sequence of the application program displayed on the display screen 105.

Step 143, reading a display node in the queue, and performing image rendering on the display node according to the image rendering parameter.

Performing image rendering on the display node according to the image rendering parameter is to render the display node according to image greyscale, image contrast, and image saturation. For example, the greyscale, contrast, and saturation of the display node are adjusted to the greyscale, contrast, saturation, corresponding to the current ambient brightness, etc.

Step 144, writing the rendered display node into a memory space corresponding to the display node.

Step 145, superimposing layers corresponding to the memory space with written display node, and transferring the superimposed data to a display screen via a drive program interface for display.

The process of superimposing layers corresponding to the memory space with a written display node can be completed by an image synthesizer of the mobile terminal 100.

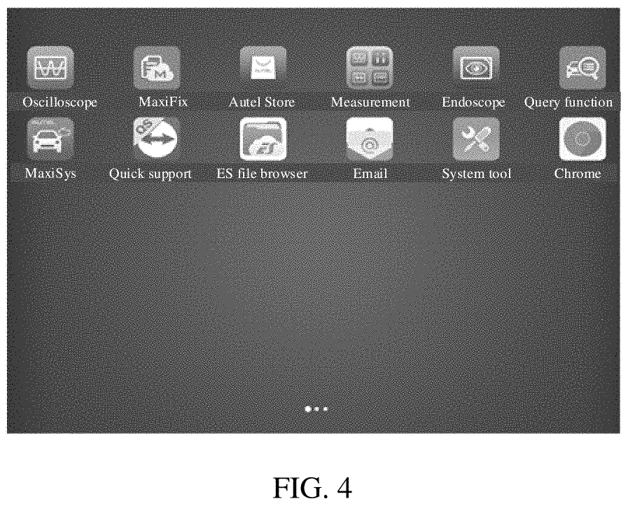

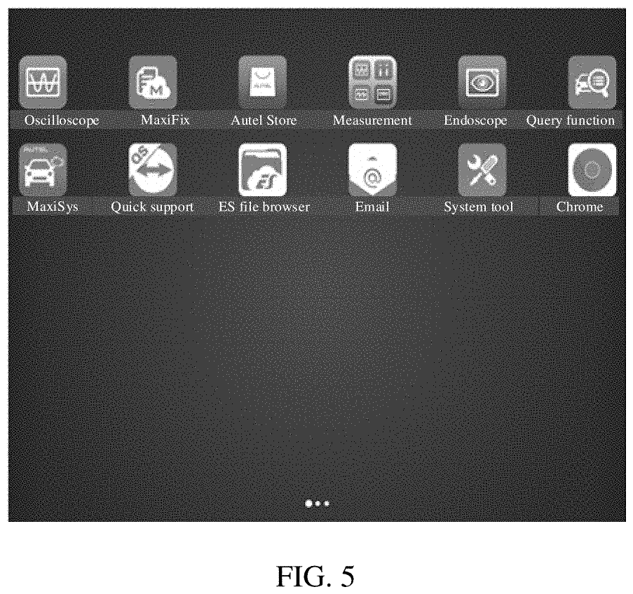

In the present embodiment, the above-mentioned rendering is implemented by a system sampling ambient light to obtain the rendering parameters of an image. During the rendering process of an image GPU (graphics processing unit), the effect of the image is transformed to change the display effect of the image to make the image look “brighter”. For example, referring to FIG. 4 and FIG. 5. FIG. 4 is an effect picture before image enhancement, and FIG. 5 is an effect picture after image enhancement by the above rendering way.

It should be noted that the above-mentioned adjusting the screen brightness of the mobile terminal 100 according to the screen brightness adjustment parameter is mainly to adjust the screen brightness according to the backlight reference current and the image rendering parameter. In other embodiments, the screen brightness may also be adjusted according to other parameters.

In addition, the main application scenario of the present embodiment is that when the ambient light is high brightness, the image display effect becomes clear not by turning up the backlight reference current, but mainly by rendering the image displayed on the screen. In other embodiments, the above-described method may also be used to adjust the display effect of the screen when the ambient light is not high brightness. For example, the display effect of the screen image can be adjusted according to the rendering parameters by rendering the image according to the change of the ambient light, and the backlight current can be maintained within one suitable range. Therefore, not only the display effect of the screen can be improved, but also the power consumption can be reduced.

In the present embodiment, the screen brightness adjustment method comprising: acquiring an ambient brightness value of a current application environment and a backlight level of a mobile terminal; acquiring a screen brightness adjustment parameter according to the ambient brightness value when the ambient brightness value and the backlight level of the mobile terminal both satisfy a preset condition; and finally adjusting a screen height of the mobile terminal according to the screen brightness adjustment parameter, wherein the screen brightness adjustment parameter comprises a backlight reference current and an image rendering parameter. This implementation mode renders the image displayed by the screen mainly by the image rendering parameters, and at the same time adjusts the backlight reference current to be within a suitable range of the backlight current, thereby not only making the display effect of the screen clear, and making the screen display effect meet the requirements of the current application environment, but also reducing the power consumption of the system.

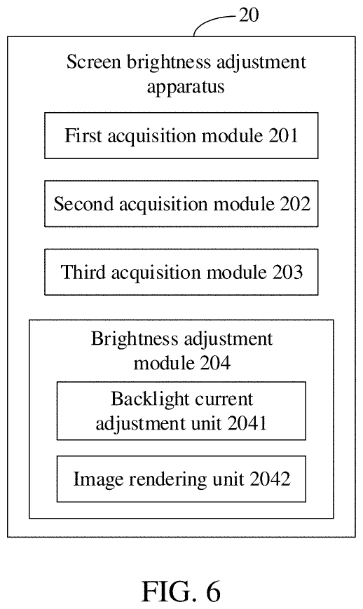

Referring to FIG. 6, FIG. 6 is a schematic view showing the structure of a screen brightness adjustment apparatus provided by an embodiment of the present application. The screen brightness adjustment apparatus 20 is applied to the mobile terminal 100, and the apparatus 20 comprises: a first acquisition module 201, a second acquisition module 202, a third acquisition module 203, and a brightness adjustment module 204.

The first acquisition module 201 is configured to acquire an ambient brightness value of a current application environment; the second acquisition module 202 is configured to acquire a backlight level of the mobile terminal; the third acquisition module 203 is configured to acquire a screen brightness adjustment parameter corresponding to the ambient brightness value when the ambient brightness value is greater than a first preset threshold value and the backlight level is greater than a second preset threshold value; the brightness adjustment module 204 is configured to adjust the screen brightness of the mobile terminal according to the screen brightness adjustment parameter.

The third acquisition module 203 is further configured to: when the ambient brightness value is greater than a first preset threshold value and the backlight level is greater than a second preset threshold value, search for a backlight reference current and an image rendering parameter corresponding to the ambient brightness value in a preset mapping table, wherein the screen brightness adjustment parameter includes the backlight reference current and the image rendering parameter.

The brightness adjustment module 204 comprises a backlight current adjustment unit 2041 and an image rendering unit 2042. The backlight current adjustment unit 2041 is configured to adjust the backlight reference current of the mobile terminal to the acquired backlight reference current; the image rendering unit 2042 is render the image displayed on the display screen 105 according to the image rendering parameter.

The image rendering unit 2042 is specifically further configured to: respectively set a layer for an application program displayed on the screen, and apply for a memory space for each layer; decomposing a UI icon of the application program displayed on the screen into a display node, and store the display node in a preset queue; read a display node in the queue, and perform image rendering on the display node according to the image rendering parameter.

The image rendering parameter comprises image greyscale, image contrast, and image saturation.

It should be noted that the screen brightness adjustment apparatus 20 provided in the present embodiment can execute the screen brightness adjustment method provided in the above-mentioned embodiment, and has functional modules and advantageous effects corresponding to the method execution. For technical details not described in detail in the embodiment of the screen brightness adjustment apparatus, reference can be made to the screen brightness adjustment method provided by the embodiment of the present application.

An embodiment of the present application provides a screen brightness adjustment apparatus, which acquires an ambient brightness value of a current application environment and a backlight level of a mobile terminal, acquires a screen brightness adjustment parameter according to the ambient brightness value when the ambient brightness value and the backlight level of the mobile terminal both satisfy a preset condition, and finally adjusts a screen height of the mobile terminal according to the screen brightness adjustment parameter, wherein the screen brightness adjustment parameter comprises a backlight reference current and an image rendering parameter. This implementation mode renders the image displayed by the screen mainly by the image rendering parameters, and at the same time adjusts the backlight reference current to be within a suitable range of the backlight current, thereby not only making the display effect of the screen clear, and making the screen display effect meet the requirements of the current application environment, but also reducing the power consumption of the system.

Finally, it should be noted that: the above embodiments are merely illustrative of the technical solutions of the present application, rather than limiting it; combinations of technical features in the above embodiments or in different embodiments are also possible under the idea of the present application, and the steps can be implemented in any order; there are many other variations of the different aspects of the present application as described above, which are not provided in detail for the sake of brevity; although the present application has been described in detail with reference to the foregoing embodiments, those of ordinary skills in the art will appreciate that the technical solutions disclosed in the above-mentioned embodiments can still be modified, or some of the technical features thereof can be replaced by equivalents; such modifications or replacements do not depart the essence of the corresponding technical solution from the scope of the technical solutions of embodiments of the present application.

What is claimed is:

1. A screen brightness adjustment method applied to a mobile terminal, the method comprising the following steps:
acquiring an ambient brightness value of a current application environment;
acquiring a backlight level of the mobile terminal;
acquiring a screen brightness adjustment parameter corresponding to the ambient brightness value when the ambient brightness value is greater than a first preset threshold value and the backlight level is greater than a second preset threshold value; and
adjusting the screen brightness of the mobile terminal according to the screen brightness adjustment parameter.

2. The method according to claim 1, wherein the step of acquiring a screen brightness adjustment parameter corresponding to the ambient brightness value comprises:
searching for a backlight reference current and an image rendering parameter corresponding to the ambient brightness value in a preset mapping table, wherein the screen brightness adjustment parameter comprises the backlight reference current and the image rendering parameter.

3. The method according to claim 2, wherein the step of adjusting the screen brightness of the mobile terminal according to the screen brightness adjustment parameter comprises:
adjusting a backlight reference current of the mobile terminal to an acquired backlight reference current; and
rendering an image displayed on a display screen of the mobile terminal according to the image rendering parameter.

4. The method according to claim 3, wherein the step of rendering an image displayed on the display screen of the mobile terminal according to the image rendering parameter comprises:
setting a layer respectively for application programs displayed on the display screen, and applying for a memory space for each layer;
decomposing a UI icon of the application program displayed on the screen into a display node, and storing the display node in a preset queue; and
reading a display node in the queue, and performing image rendering on the display node according to the image rendering parameter.

5. The method according to claim 2, wherein the image rendering parameter comprises image greyscale, image contrast, and image saturation.

6. A mobile terminal, comprising a light sensor and a microprocessor, wherein:
the light sensor is configured to collect an ambient brightness value of a current application environment; and
the microprocessor comprises at least one processor, and a memory communicatively connected to the at least one processor, the memory storing an instruction executable by the at least one processor, and the instruction being executed by the at least one processor to enable the at least one processor to execute:
acquiring the ambient brightness value;
acquiring a backlight level of the mobile terminal;
when the ambient brightness value is greater than a first preset threshold value and the backlight level is greater than a second preset threshold value, acquiring a screen brightness adjustment parameter corresponding to the ambient brightness value; and
adjusting a screen brightness of the mobile terminal according to the screen brightness adjustment parameter.

7. The mobile terminal according to claim 6, wherein the screen brightness adjustment parameter comprises a backlight reference current and an image rendering parameter; and
the processor is further configured to search for a backlight reference current and an image rendering parameter corresponding to the ambient brightness value in a preset mapping table.

8. The mobile terminal according to claim 7, wherein the processor is further configured to adjust a backlight reference current of the mobile terminal to an acquired backlight reference current.

9. The mobile terminal according to claim 7, wherein the mobile terminal further comprises an image processor, and the image processor is configured to render an image displayed on the screen according to the image rendering parameter.

10. The mobile terminal according to claim 9, further comprising a drive program interface and a display screen, wherein the image processor is configured to:
set a layer respectively for application programs displayed on the screen, and apply for a memory space for each layer;
decompose a UI icon of the application program displayed on the screen into a display node, and store the display node in a preset queue;
read a display node in the queue, and perform image rendering on the display node according to the image rendering parameter;
write rendered display node into a memory space corresponding to the display node;
superimpose layers corresponding to the memory space with written display node, and transmit superimposed data to the drive program interface;
wherein the drive program interface is configured to transmit the superimposed data to the display, and the display screen is configured to display a rendered image.

11. A screen brightness adjustment apparatus applied to a mobile terminal, the apparatus comprising:
a first acquisition module configured to acquire an ambient brightness value of a current application environment;
a second acquisition module configured to acquire a backlight level of the mobile terminal;
a third acquisition module configured to acquire a screen brightness adjustment parameter corresponding to the ambient brightness value when the ambient brightness value is greater than a first preset threshold value and the backlight level is greater than a second preset threshold value; and
a brightness adjustment module configured to adjust the screen brightness of the mobile terminal according to the screen brightness adjustment parameter.

12. The apparatus according to claim 11, wherein the third acquisition module is further configured to search for a backlight reference current and an image rendering parameter corresponding to the ambient brightness value in a preset mapping table, and wherein the screen brightness adjustment parameter comprises the backlight reference current and the image rendering parameter.

13. The apparatus according to claim 12, wherein the brightness adjustment module comprises a backlight current adjustment unit and an image rendering unit, wherein:
the backlight current adjustment unit is configured to adjust a backlight reference current of the mobile terminal to an acquired backlight reference current; and
the image rendering unit is configured to render an image displayed on a display screen of the mobile terminal according to the image rendering parameter.

14. The apparatus according to claim 13, wherein the image rendering unit is further configured to:
set a layer respectively for application programs displayed on the display screen, and apply for a memory space for each layer;
decompose a UI icon of the application program displayed on the screen into a display node, and store the display node in a preset queue; and
read a display node in the queue, and perform image rendering on the display node according to the image rendering parameter.

15. The apparatus according to claim 12, wherein the image rendering parameter comprises image greyscale, image contrast, and image saturation.
